(19) United States
(12) Patent Application Publication
(10) Pub. No.: US 2012/0152113 A1
(43) Pub. Date: Jun. 21, 2012

(54) Gas Humidification and Pressure Control

(75) Inventor: Truls Norby, Kloeftaveien (NO)

(73) Assignee: NORECS NORWEGIAN ELECTRO CERAMICS AS, Oslo (NO)

(21) Appl. No.: 13/382,169

(22) PCT Filed: Jul. 8, 2010
(86) PCT No.: PCT/EP2010/004167

§ 371 Date: Mar. 12, 2012

(30) Foreign Application Priority Data
Jul. 9, 2009 (US) 61224354

(51) Int. Cl. F24F 6/00; B01F 3/04

(52) U.S. Cl. 95/19; 261/121.1

(57) ABSTRACT

An apparatus for humidification and pressure control of gas. The apparatus may include a container for holding an aqueous liquid, a first tube for receiving gas from a gas source and being arranged to pass the gas into the liquid through an opening at a lower end of the tube, and a second tube for discharging the gas from an upper portion. The second tube may surround the first tube and may include an opening at its lower end that is below the lower end of the first tube.

The invention relates to an apparatus for and method of gas humidification and pressure control.

Many small laboratory applications and devices such as fuel cell tests, membrane tests, or annealing furnaces, need a moderate flow of a gas of a certain composition, delivered at near atmospheric pressure. In some cases the gas needs to be dry, in some cases humidity does not matter, and in some cases the gas needs to be humidified.

The humidity may be required because it is an essential part of the required atmosphere, such as in annealing to hydrate materials or in chambers for biological material that must be prevented from drying out. It may furthermore be necessary to humidify the fuel in many types of fuel cells, to avoid anode embrittlement or coking. For tests of proton conducting fuel cells humidification may be needed both for the anode and cathode gases (fuel and oxidant). It may in other cases be an important part of the atmosphere because it emulates real operating conditions, e.g. in ambient (humid) air.

The pressure is usually required to be near-atmospheric because the laboratory apparatus is not designed for any degree of overpressures. Typically, it will be desirable to keep the pressure below a maximum level to avoid the risk of damage to the equipment or injury to the operator.

Another requirement in this field is the control and indication of gas flow. This can be important for quantitative inspection and evaluation of the operation of the apparatus, and also for qualitative indication of main operational parameters of the cell being studied. An example is the flow through the chambers of a fuel cell or gas separation membrane reactor that indicates that the cell chambers are properly sealed and that the in- and outlets are not blocked by e.g. condensed water, coke, or tar.

There is therefore a need for a way of providing humidified and pressure controlled gas in the laboratory for a variety of applications, along with an indication of the flow of gas being given. Existing technologies and products aimed at meeting this need can be classified into two groups, each having problems and disadvantages.

First, known commercially available systems for humidification and pressure/flow control, for instance for fuel cells, are oversized for small and laboratory testing applications. In addition, for fuel cell testing the regulation of pressures—both the total pressure and the possibility to vary small pressure differences between the two cell chambers—is too coarse. This is typically a result of the use of mechanical pressure regulators that cannot maintain very small pressure gradients. It may also be a result of thermal mass flowmeters and controllers that are designed for certain pressure ranges. The resulting pressure differences and changes in pressure may easily break thin, fragile ceramic sample membranes or press open many types of sealing. For other, simpler, uses, like simple supply of gas to a reaction, annealing, or sintering furnace, a commercial gas supply unit may be suitable and functional, but often considered too expensive. Thus, commercial systems are often too coarse for certain purposes, and too expensive for many users.

The second group of problems concerns users who build a home-made system for humidification and control of gas flows. Their decision to do so may have economic reasons, but it may also result from the desire to avoid the coarse controls of oversized commercial systems. The homemade systems may then cause hazards due to insufficient safety against overpressure build-up and use of glass apparatus that may break or explode.

Viewed from a first aspect, the invention provides an apparatus for humidification and pressure control of gas, the apparatus comprising: a container for holding an aqueous liquid; a first tube for receiving gas from a gas source and being arranged to pass the gas into the liquid through an opening at a lower end of the tube; and a second tube for discharging the gas from an upper portion, the second tube surrounding the first tube and comprising an opening at its lower end that is below the lower end of the first tube.

With this arrangement, the apparatus provides humidification using the first (inner) tube by bubbling the gas through the aqueous liquid via the opening, which is placed below the surface of the liquid when the apparatus is in use. The gas is bubbled out of the first (inner) tube into the second (outer) tube, where it rises up through the column of liquid within the second tube, and can then be delivered to an external device, such as a furnace chamber or fuel cell or other device as discussed above. The desired humidification effect is provided by passage of the gas through the column of aqueous liquid in the second tube. The bubbling system also usefully provides a visual indication of the flow of gas through the apparatus. An over-pressure relief system for pressure control is provided by the outer tube, because should the pressure in the outer tube increase, for example when the flow of gas through the outlet is blocked or restricted, then the gas pressure in the outer tube will push the column liquid down until gas can escape from the opening in the lower end of the outer tube. This gas will exit into the container and can then be discharged from the apparatus, for example to a hood or other safe ventilation.

As a result, humidification and pressure control (over-pressure relief) functions are provided simultaneously by the same structure without the need for complex components or moving parts. Tough plastic components may be used instead of glass, which might otherwise be used in some home-made systems. A harmless aqueous liquid can be used and as a result the only hazardous material in the apparatus will be the gas itself. In normal use this gas is contained within the headspace of the second tube, and is only released to atmosphere or to safe ventilation if there is a problem with the gas flow and the over-pressure relief is activated. As the water column in the second tube falls and bubbles on the outside eventually appear when the pressure builds up, there is a clear and easily recognisable visual indication of a problem.

The aqueous liquid may be any liquid suitable for the desired humidification. In most applications, water may be used. Often, pure (e.g. distilled) water will be preferred.

In the preferred embodiments of the invention the tubes are circular tubes, i.e. hollow cylinders. However, the term ‘tube’ as used herein is not limited to circular tubes and instead is intended to mean any hollow prism. For example, rectangular or elliptical tubes could be used to achieve the same humidification and pressure control. Circular tubes are preferred as appropriate tubes or hoses are readily available and also the circular shape gives good strength.

Preferably, the apparatus comprises an inlet for receiving gas from a gas source, wherein the inlet is coupled to the first tube to allow gas to flow into the first tube, along the tube, out the open end and into the liquid. The apparatus may also include an outlet for delivering humidified and pressure controlled gas to an external device, wherein the outlet is coupled to the second tube to allow gas flowing through the liquid into a headspace of the second tube to exit the apparatus. The inlet and/or the outlet may be provided with any suitable connector or coupling to be joined to external gas lines and hence joined to a gas source and external device respectively.

The container may be open to atmosphere, i.e. in its simplest construction the apparatus comprises a container in the form of a beaker or bucket or the like, with the two tubes hanging down, and liquid filling the beaker above the base of the inner tube when the apparatus is in use. However, preferably the container is a closed vessel with an outlet vent for discharge of over-pressure relief gas. The vent may be a tube or hole in a wall or lid of the container. In a preferred embodiment the vent is connectable to a gas line for discharge of gas to outside ventilation or a hood. With this arrangement, any hazardous gas, e.g. a fuel gas, can be safely conveyed away from the laboratory or test site.

Preferably, the first and second tubes are secured to the top of the container, for example they may be sealed in a hole through a lid of the container.

In a preferred embodiment, the apparatus comprises a third tube for receiving process gas from an external device, the third tube being arranged to pass the process gas into the liquid through an opening at a lower end of the tube. With this arrangement, the gas stream passing to and from an external device can be routed through the apparatus, and the gas bubbling into the liquid from the third tube provides a useful visual indication of flow of process gas away from the external device. Bubbling the gas into a liquid also ensures that the gas at the third tube is above ambient pressure, which can avoid undesirable leakage of ambient air into the external device.

Preferably, the opening at the lower end of the third tube is above the opening at the lower end of the first tube. For example, the opening of the first tube may be arranged to be at a depth of 10-20 cm in the liquid, whereas the opening of the third tube may be arranged to be at a depth of 1-5 cm in the liquid. This height differences ensures that there is a pressure difference between the gas in the first and third tubes, which will act to drive gas through the external device.

With the use of a third tube, process gas will flow into the headspace of the container and can be discharged in the same manner as the over-pressure relief gas, e.g. via the outlet vent. Advantageously, this allows flushing of the container with the process gas, which, in the case of overpressure relief through the second tube, prevents still air entering the container and mixing with a flammable/explosive gas delivered through the apparatus, which would produce a dangerous explosive mixture.

There may be a fourth tube surrounding the third tube. Whilst a fourth tube is not necessary for operation of the third tube, the use of a fourth tube allows the third tube to be supported in the container in a similar manner to arrangement of the first and second tubes, and hence means that repeated similar components can be used. The fourth tube may have a hole arrange to be above the level of liquid, for discharge of process gas that bubbles out of the third tube. Process gas then passes to the container and can be vented with the over-pressure relief gas. Alternatively, the fourth tube may include a mechanism for separate discharge of process gas, such as an outlet or vent at an upper end of the fourth tube. This arrangement is beneficial if the process gas needs to be treated differently to the over-pressure relief gas, for example if the process gas is toxic or otherwise hazardous, or if some further processing or analysis of the process gas is required.

The heights of any or all of the first, second, third and/or fourth tubes may be adjustable relative to the container and to one another. For example, the tube(s) may be arranged to slide vertically through their supports relative to the container and/or relative to one another. This allows small pressure adjustments of the gas flowing through the first or third tubes, and also enables adjustment of the over-pressure relief function of the second tube. The container is filled with liquid when in use, and the level of the liquid may be adjusted as another mechanism to adjust pressures.

Two similar apparatuses may be used for independent parallel humidification, pressure control and flow visualisation of two streams of two separate gases. The two gases may, for example, be the fuel and oxidant gases for a fuel cell, or feed and permeate gases for a membrane test. In a preferred arrangement, each apparatus includes a third tube as set out above, and the third tubes are adjustable to different heights. This enables the pressure of the returned process gas to be different in each gas stream. This can help assess gas tightness of the external, device and/or may in some cases be of benefit in inducing a small flow of gas from one stream to another within the external device.

Viewed from a second aspect, the invention provides a method of humidification and pressure control of gas using an apparatus comprising: a container holding an aqueous liquid; a first tube having an opening at a lower end immersed in the liquid; and a second tube surrounding the first tube and comprising an opening at its lower end that is below the lower end of the first tube; the method comprising: supplying gas to the first tube and passing the gas through the opening into the liquid to thereby bubble the gas up through a column of liquid in the second tube, and discharging the treated gas through an upper portion of the second, tube.

As with the above first aspect, the method of the second aspect provides humidification and a visual indication of the flow of gas, whilst simultaneously including an over-pressure relief system for pressure control through the lower end of the second (outer) tube.

The apparatus utilised in the method may include preferred features as set out above and corresponding method steps. For example, the apparatus may comprise a third tube with an opening at its lower end immersed in the liquid, and the method may include supplying process gas from an external device to the third tube, passing the process gas into the liquid through an opening at a lower end of the tube, and thereafter discharging the process gas.

The method may include adjusting the heights of any of the first, second, third and/or fourth tubes, as the case may be, to achieve pressure control as set out above. In a preferred embodiment, the method comprises the use of two similar apparatuses for independent parallel humidification, pressure control and flow visualisation of two streams of two separate gases. With this feature, the method preferably includes adjusting the height of third tubes of each apparatus to thereby adjust the pressure of the returned process gas in each gas stream.

In a further aspect, the invention extends to a kit of parts provided for assembly into the apparatus of the first aspect and/or the preferred features thereof. Thus, a third aspect of the invention provides a kit of parts comprising: a container for holding an aqueous liquid; a first tube for receiving gas from a gas source at one end and being arranged to pass the gas into the liquid through an opening at another end of the tube; and a second tube for discharging treated gas at a first end and comprising an opening at a second end, wherein the first tube is smaller in diameter than the second tube such that the first tube can be placed within the second tube; the kit of parts further comprising a support and sealing arrangement adapted to support the first tube within the second tube with the opening of the first tube being higher than the opening of the second tube, support the two tubes within the container for partial immersion in the liquid, and seal the connection between the two tubes such that gas passed into the first tube can bubble up through a column of liquid in the second tube and be discharged from the first end of the second tube.

The support and sealing arrangement may be a system of lids or plugs provided with holes for the tubes, and seals to provide gas-tightness. Optional features of the kit of parts and the support and sealing arrangement will be evident from the discussion of the first aspect and from the discussion of the features of the preferred embodiments set out below.

The invention and preferred embodiments therefore thus provide a simple, safe and inexpensive solution to the problem of providing humidified and pressure controlled gas. It makes use of one volume of aqueous liquid for both humidification, overpressure safeguarding, flow visualisation and optionally pressure difference control. It utilises materials and construction that make the apparatus simple, safe, and affordable. It is less expensive and works more finely and manually and intuitively (also pedagogically) than large commercial and often automated systems, and compared to typical low-budget home-made gas line assemblies it offers safer operation and a range of advantageous features. The pressures involved are close to ambient atmospheric pressure (1 atm) and the humidification not higher than room temperature dew point (ca. 3% H₂O, or pH₂O=0.03 atm), making the invention suitable for a wide range of uses.

Certain preferred embodiments of the invention will now be described by way of example only and with reference to the accompanying drawings, in which:

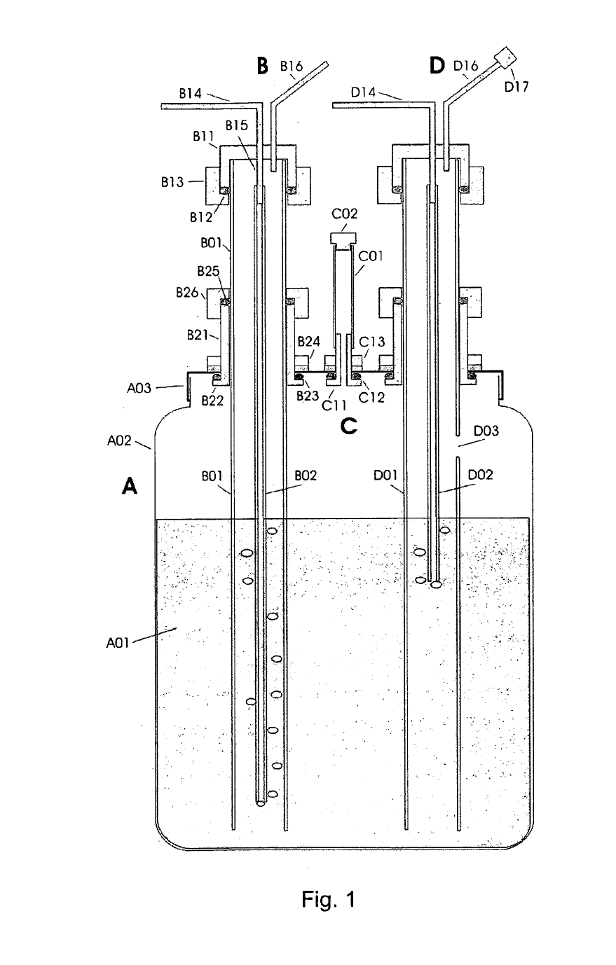

FIG. 1 shows an apparatus for gas humidification and pressure control,

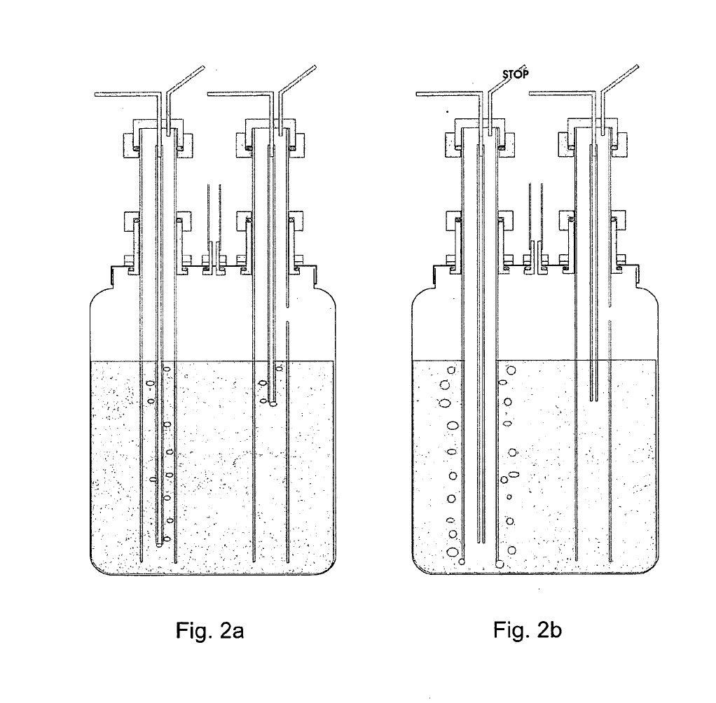

FIG. 2a illustrates the apparatus of FIG. 1 in normal operation,

FIG. 2b shows the apparatus in the situation when the flow of gas to the external device is restricted,

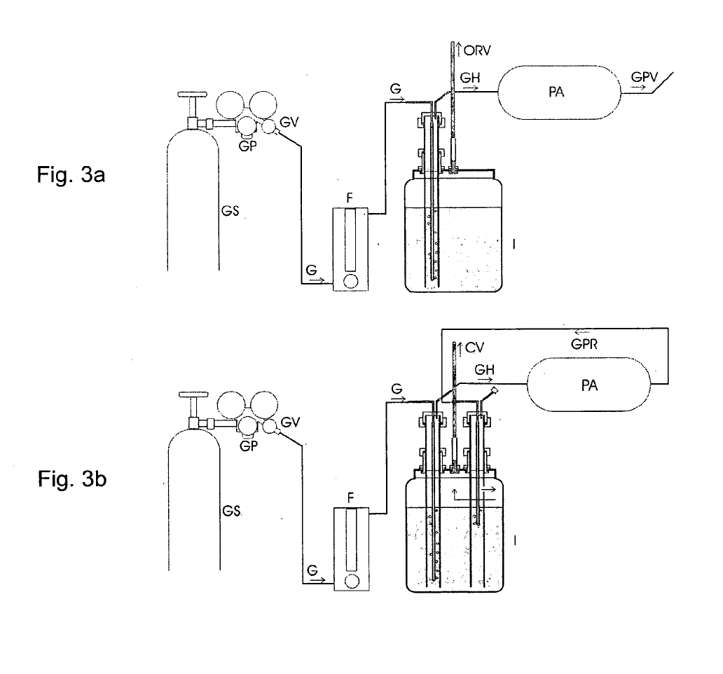

FIG. 3a is a diagram showing the implementation of the humidifier and overpressure safeguard for single gas supply to a process application,

FIG. 3b shows a similar implementation for single gas supply to a process application, with use of a second bubbler for return process gas, and

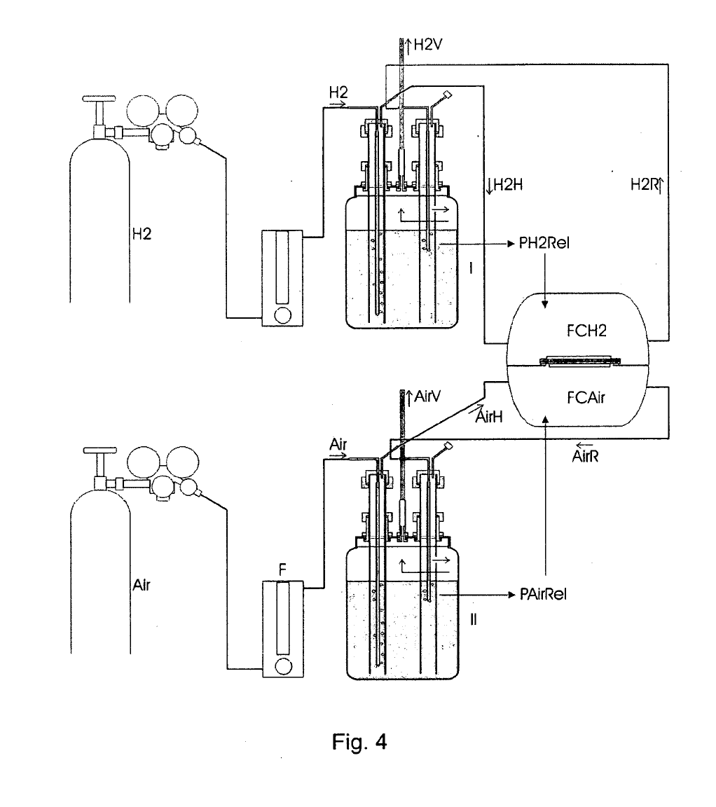

FIG. 4 shows an arrangement of two humidification and pressure control devices used for supply of two different gases to a fuel cell.

A preferred embodiment of the invention with optional additional features is illustrated in FIG. 1, with numbers for identification of parts and function referenced in this section.

The volume of water A01 is held in a container A, A02 made of a transparent polymer, for inspection and safety in case of explosion. The polymer can be coated with an antistatic agent to further increase safety if used with flammable/explosive gas or in rooms where such gases may be used.

The container has a lid A03 to which all further components are fastened. The lid may be fastened gastight to the container like a normal household screw lid, or it may be made as a bell standing in the container.

The lid has two or three holes to accommodate the parts described below. The necessary parts are the humidification and overpressure safeguard double bubbling tube B and the stub for gas to ventilation outlet and water filling C. The optional part is the return gas pressure control and flow verification bubbler D.

The double bubbler B consists of an approximately 2 cm diameter plexiglass outer tube B01 and an inner thinner hose or plexiglass tube B02 ending a little higher than the outer one. The inner tube B02 forms the first tube discussed above, and the outer tube B01 forms the second tube discussed above and in the claims.

On the top of the outer plexiglass tube B01 is a cap B11 of metal or hard polymer, fixed gastight to the tube. This can be done with the help of an O-ring B12 and nut B13. Alternatively, it can be done by screw treads in the plexiglass and cap and an O-ring at the end of the tube. It can also be done by simple gluing.

A gas inlet tube B14 comes from the outside and forms a stub B15 in the inside centre of the cap. The gastight feed-through and fixing of the gas tube through the cap can be done with soldering, welding, or gluing, depending on the materials chosen.

To the stub B15 is attached an inner tube in the form of a length of hose or a thin plexiglass tube B02 connected via a short hose. The length should be adjusted to be somewhat shorter (e.g. between 0.5 cm and 2 cm shorter, preferably about 1 cm shorter) than the bottom opening of the outer tube B01 that it sits inside. This avoids escape of gas from the outer tube B01 during normal operation.

Under normal operation gas enters the inner tube B02 via the gas inlet B14 and then bubbles from the inner tube B02 into the outer tube, B01. Under normal operation the bubbles flow up through the liquid in the outer tube B01 and into the cap volume. An outlet gas tube B16 on the side of the centred inner tube forms the outlet from the cap volume to the external device (process application).

The outer plexiglass tube B01 is fed through the container lid using a machined tube B21 of metal or hard polymer. It has a collar B22 and screw thread on the outside. Fastening and sealing to the lid is done by help of the collar B22, an O-ring B23, and washer and nut B24. Fastening and sealing of the plexiglass tube is done with an O-ring B25 and nut B26.

All nuts and their threaded counterparts mentioned above can be made with geometry for wrenches or with finger-grip, or both.

The gas, coming in from a flow-regulator (e.g. mass flow controller or manual needle valve) will bubble into the water and up into the outer plexiglass tube and out through the outlet. The gas is humidified as it passes through the water. The gas goes from the outlet B16 to the application, e.g. a furnace chamber or a chamber of a fuel cell. This normal operation is shown in FIG. 1 and FIG. 2a

The container has an outlet C to the ambient atmosphere that can be connected to ventilation or hood with a hose C01. The parts of the outlet comprise stub with collar C11, O-ring C12, and washer and nut C13. The outlet can be used also to refill water.

If the application is blocked accidentally or by deliberate action (e.g. disconnection of auto-shutoff valve connects or closure of a manual valve) the pressure will start building up in the top of the outer tube B01. This will press the water column of the outer plexiglass tube B01 down and gas will start bubbling out of the base of the column, as a safeguard against overpressure, as shown in FIG. 2b. Thus, as the pressure increases, the water column in the outer tube B01 drops until gas bubbles out of this tube, into the container A, A02 and out through the ventilation outlet C.

The apparatus may include a second bubbler stage D, as discussed below. In this event a common gas outlet can be arranged via the second stage D, in which case a stop C02 (e.g. plug, stopcock, or valve) can be mounted to the outlet C hose C01 or stub C11. In this case, the outlet C is well suited for refill of water by removing the stop.

In the way described above, the gas is both humidified and safeguarded against overpressure higher than that of the water column of the outer tube, i.e. 10-20 centimetres.

The large container and lid can be equipped with a second bubbler D. This serves to receive the return gas from the application, adjust its overpressure, provide a visual indication of its flow, route it to ventilation if necessary through the common outlet C, and thereby also provide flushing of the container gas volume with the process gas. This prevents still air entering the container and mixing with a flammable/explosive gas delivered through the first bubbler stage B. The optional second bubbler and numbers for identification of parts and functions referenced below are included in FIGS. 1 and 2.

The optional second bubbler D is simpler that the first bubbler B in the sense that it only comprises one bubbling function, through the inner thin tube D02. The outer tube D01 could be removed. However, the second bubbler D can be made and described from the same parts as the first (double) bubbler B because the outer tube D01 serves to fasten the assembly to the container lid, in a way by which the height of the assembly, and thus the bubbling depth, can be adjusted. The inner tube D02 and outer tube D03 of the second bubbler D form the third and fourth tubes discussed above and in the claims.

The second bubbler D is fed from the application through its inlet tube D14. Its inner, thin bubbling hose or tube D02 should be cut to a shorter length than in the first bubbler B so that it only is immersed a few centimetres. This ensures that there is a sufficient pressure difference between the first and second bubbler to drive the gas through the application.

The outlet to ventilation of the process gas after bubbling through the second bubbler D can be arranged in different ways. The intended typical arrangement is to let process gas into the container A02 through a hole D03 in the outer tube D01. The gas then proceeds to the common outlet C, flushing the gas in the container A02 on its way. In this mode, the second bubbler's top outlet D16 may be omitted, or it may be stopped by a plug or the like D17. The hole D03 in the outer tube D01 is placed midway between the upper water level (which should be accordingly marked on the container A) and the lid to allow adjustment of the height of the second bubbler D.

Alternatively, the process gas can exit via the top outlet D16. In this case, overpressure relief gas from the first bubbler B can escape by this gas entering the hole D03 from the container volume into the outer tube D1 of the second bubbler D and then exits via its outlet D16, which can be connected to a vent or hood. In this case, the stop D17 must of course be omitted or open. The potential advantage of this way of arranging outlets is that it may be convenient to connect of the outlet line to the bubbler outlet D16 and retaining of the common outlet C for water refill only. One may also let the overpressure relief gas exit through the container outlet C and the process gas from the second bubbler D exit through its top outlet D16 if required, which might be useful depending on the nature of the gases. In this case the hole D03 in the second bubbler tube D01 may be omitted or closed. These ways, however, do not flush process gas through the container volume and thus do not take the advantage of the increased safety normally achieved by this, and should only be chosen if the gas handled is not explosive. They may however be advantageous options if the gas process gas is more or potentially more hazardous than the original gas supplied through the device, for instance that it may contain irritant or toxic components or an unstable mixture after the process.

To summarise from the above, the second bubbler D serves a number of purposes:

(i) the bubbling gives the cell or furnace chamber a certain small overpressure that prevents in-diffusion of ambient air components through leakages;

(ii) the bubbling itself provides a simple visual verification that the gas is flowing through the application and that the system is gastight, so that the gas ends up in the outlet in a controlled manner; and

(iii) the bubbling ensures flushing of the whole system with the same process gas, including the device's volume over the water level, so that this gas in case of overpressure relief, is the same as the process gas and that no explosive mixture with residual air is formed.

The design allows alternative arrangements to the flushing and common outlet without imposing cost-driving complications in the number of different parts or in the manufacture.

The use of two full devices (I and II) each with a second bubbler D, allows the independent humidification, overpressure safeguard, overpressure control, and flow visualisation of two gases. This is illustrated in FIG. 4 and discussed in more detail below. The two gases may, for instance, be the fuel and oxidant gases for a small laboratory fuel cell system, or the feed and permeate gases for a membrane permeation measurement setup.

The use of outlet gas bubbling for both gases ensures visual inspection that both gases return properly, and are not blocked and do not escape through a leakage to the exterior or between each other.

The return gas bubbling can now furthermore be adjusted to different heights of the inner tube(s) D02 by sliding the outer tube(s) D01 vertically. This pressure difference will in the case of a gas-tight fuel cell have no consequence on the two flows. A leakage in the seal or otherwise between the two chambers will, on the other hand, give a higher flow and bubbling rate in the outlet gas bubbling to the lower pressure.

In this way the apparatus provides a simple way of checking gas tightness, and it provides the possibility to deliberately apply small pressure differences that may help make the sealing or induce a small leakage flow in one direction that is considered safe or beneficial for cell performance.

The implementation of the apparatus and method in example systems will now be described with reference to FIGS. 3a, 3b and 4.

FIGS. 3a and 3b illustrate supply of a single gas G through the device I for humidification and overpressure safeguarding, leading humidified gas GH to a process application PA. The gas is assumed supplies from a compressed gas supply GS through some pressure regulator GP and through a flow controlling valve GV and/or flowmeter F.

In FIG. 3a the second bubbler D is not used. The process gas is led directly to ventilation GPV and the overpressure relief gas is led to ventilation separately ORV via the outlet C of the device I.

In the arrangement of FIG. 3b, the second bubbler D shown in FIG. 1 is used to receive the return process gas GPR, give it a slight overpressure, provide flow visualisation, and flush the container, so that overpressure relief and return process gas have common outlet to ventilation CV. In this case, the process gas GPR passes through the second inner tube D01 up the outer tube D02 and through the hole D03 into the container A02, as discussed above in relation to FIGS. 1 and 2.

FIG. 4 illustrates how the device may be used in a pair for controlling the supply of gas to a fuel cell test (or other membrane application). The gases are exemplified as hydrogen H2 and Air. Hydrogen is supplied to the first (top) device I and humidified and overpressure safeguarded. Humidified hydrogen H2H is supplied to the fuel cell hydrogen electrode chamber FCH2 and return hydrogen H2R is sent back to the second bubbler of the first device I for control of overpressure PH2Rel and flow. Air is correspondingly fed through the second device II to the fuel cell air electrode chamber FCAir and returned to control its relative pressure PAirRel and flow.

With this arrangement, changing the heights of the two return gas bubblers can finely adjust the pressures of the two gases relative to each other and to the ambient atmosphere. This aids in optimising conditions to protect a fragile membrane or similar component. The visual indication of the flows provided by the bubblers helps evaluate the function of the cell or membrane, including the gas tightness of the sealing.

Further variations and additions are possible. In a dual gas system with two devices, the water volumes of the containers may be connected e.g. by taps and a hose mounted near the bottom of the containers (A, taps and hose not shown in the figures). This allows refilling of water to be done through only one of the devices, and the water levels will remain equal during slow evaporation as well as fast refilling. This enables a constant equality or difference between the pressures in the two process application chambers, something that may be important for instance during long-term stability and degradation tests of fuel cells.

The containers A may be immersed in a chilled water bath or chamber. This may enable a controlled temperature and humidity level, and reduces the chance of condensation in a later stage of the gas path to and from the process application.

If the lid of the device is actually a bell standing in the container, the water of the container may itself be the chilled water bath.

The containers may be equipped with water level sensors that alarm in case water level goes below a minimum. However, it may be noticed that the safety and safeguarding function of a closed container does not disappear even if water dries out completely. In that case pressure would simply be maintained at ambient pressure levels. Only if the connecting water hose or bell design is used is there a need to alarm and possibly automatically stop gas flows since the function of the water of separating the gas from the surroundings and from the other gas is then lost.

H₂ and air were supplied through flowmeters to a fuel cell test setup using an apparatus as illustrated in FIG. 4. The test comprised a high temperature sample holder and a thin button-sized fuel cell from InDEC (The Netherlands), made with yttria-stabilised zirconia (YSZ) as electrolyte, Ni—YSZ cermet anode, and a standard perovskite cathode. Sealing was done with a gold gasket.

The humidification and pressure control devices worked properly and fully as expected from the principles described herein. By deliberately stopping the one or both gas flows at the fuel cell, the overpressure relief came into action and prevented pressure build-up, fuel cell rupture, or accidents efficiently.

The pressure regulation facility of the second bubbler of both devices allowed as expected application of slight overpressure on one side during sealing, verification through flow visualisation of the sealing process, and later on optimisation of cell voltage and stable operation by fine tuning the pressure difference between the two chambers.

I claim:

1. An apparatus for humidification and pressure control of gas, the apparatus comprising:
a container for holding an aqueous liquid;
a first tube for receiving gas from a gas source and being arranged to pass the gas into the liquid through an opening at a lower end of the tube; and
a second tube for discharging the gas from an upper portion, the second tube surrounding the first tube and comprising an opening at its lower end that is below the lower end of the first tube.

2. An apparatus as claimed in claim 1, comprising an inlet for receiving gas from a gas source, wherein the inlet is coupled to the first tube to allow gas to flow into the first tube, along the tube, out the open end and into the liquid.

3. An apparatus as claimed in claim 1, comprising an outlet for delivering humidified and pressure controlled gas to an external device, wherein the outlet is coupled to the second tube to allow gas flowing through the liquid into a headspace of the second tube to exit the apparatus.

4. An apparatus as claimed in claim 1, wherein the container is a closed vessel with an outlet vent for discharge of over-pressure relief gas.

5. An apparatus as claimed in claim 1, comprising a third tube for receiving process gas from an external device, the third tube being arranged to pass the process gas into the liquid through an opening at a lower end of the tube.

6. An apparatus as claimed in claim 5, wherein the opening at the lower end of the third tube is above the opening at the lower end of the first tube.

7. An apparatus as claimed in claim 5, comprising a fourth tube surrounding the third tube, wherein the fourth tube includes a hole arrange to be above the level of liquid, for discharge of process gas that bubbles out of the third tube.

8. An apparatus as claimed in claim 5, comprising a fourth tube surrounding the third tube, wherein the fourth tube includes an outlet or vent at an upper end of the fourth tube for discharge of process gas.

9. An apparatus as claimed in claim 1, wherein the heights of any or all of the tubes is adjustable relative to the container and/or to one another.

10. A system for supply of two streams of humidified or pressure controlled gas comprising a first apparatus as claimed in any preceding claim for a first stream of gas, and a second apparatus as claimed in any preceding claim for a second stream of gas.

11. A system as claimed in claim 10, wherein each of the first and second apparatus includes a third tube, and the third tubes are adjustable to different heights.

12. A method of humidification and pressure control of gas using an apparatus comprising: a container holding an aqueous liquid; a first tube having an opening at a lower end immersed in the liquid; and a second tube surrounding the first tube and comprising an opening at its lower end that is below the lower end of the first tube; the method comprising:
supplying gas to the first tube and passing the gas through the opening into the liquid to thereby bubble the gas up through a column of liquid in the second tube, and
discharging the treated gas through an upper portion of the second tube.

13. A method as claimed in claim 12, comprising use of an apparatus as set out in claim 1.

14. A method as claimed in claim 12, comprising adjusting the heights of one or more of the tubes to achieve pressure control for the respective gas.

15. A kit of parts provided for assembly, comprising:
a container for holding an aqueous liquid;
a first tube for receiving gas from a gas source at one end and being arranged to pass the gas into the liquid through an opening at another end of the tube; and
a second tube for discharging treated gas at a first end and comprising an opening at a second end, wherein the first tube is smaller in diameter than the second tube such that the first tube can be placed within the second tube;
the kit of parts further comprising a support and sealing arrangement adapted to support the first tube within the second tube with the opening of the first tube being higher than the opening of the second tube, support the two tubes within the container for partial immersion in the liquid, and seal the connection between the two tubes such that gas passed into the first tube can bubble up through a column of liquid in the second tube and be discharged from the first end of the second tube.
